(19) United States
(12) Patent Application Publication
(10) Pub. No.: US 2018/0302832 A1
(43) Pub. Date: Oct. 18, 2018

(54) ENHANCED SERVING ACCESS POINT SELECTION IN A NETWORK HAVING MULTIPLE ACCESS POINTS

(71) Applicant: QUALCOMM Incorporated, San Diego, CA (US)

(72) Inventors: Xiaolong Huang, San Jose, CA (US); Srinivas Katar, Fremont, CA (US); Sai Yiu Duncan Ho, San Diego, CA (US); Alireza Raissinia, Monte Sereno, CA (US); Brian Michael Buesker, San Diego, CA (US); George Cherian, San Diego, CA (US); Ajay Kumar Pathak, Fremont, CA (US); Hao Zhu, Milpitas, CA (US)

(21) Appl. No.: 15/952,163

(22) Filed: Apr. 12, 2018

Related U.S. Application Data
(60) Provisional application No. 62/486,339, filed on Apr. 17, 2017.

(51) Int. Cl. H04W 36/08; H04W 36/26; H04W 36/30; H04W 36/00

(52) U.S. Cl. CPC H04W 36/08; H04W 36/26; H04W 36/0044; H04W 36/0088; H04W 36/30

(57) ABSTRACT

This disclosure provides systems, methods and apparatus, including computer programs encoded on computer-readable media, for serving AP selection in a network having multiple access points (APs). In one aspect, a serving AP selection unit can steer a device (such as a client station, STA, or a child AP) based on a quality of service profile (such as a capacity requirement or a delay requirement) of the device. The device may be initially associated with a first AP (as the current serving AP) in the network. The serving AP selection unit may select a second AP as a new serving AP for the device, and cause the device to associate with the second AP rather than the first AP. The selection of a serving AP may take into account delay or hop count in addition to path capacities for various paths in the network.

### CROSS-REFERENCE TO RELATED APPLICATIONS

This patent application claims priority to U.S. Provisional Patent Application No. 62/486,339 filed Apr. 17, 2017 entitled “ENHANCED SERVING ACCESS POINT SELECTION IN A NETWORK HAVING MULTIPLE ACCESS POINTS,” and assigned to the assignee hereof. The disclosure of the prior application is considered part of and is incorporated by reference in this patent application.

### TECHNICAL FIELD

This disclosure relates to the field of network communication, and more particularly to serving access point selection in a network having multiple access points.

### DESCRIPTION OF THE RELATED TECHNOLOGY

Wireless communication technologies can support wireless network access for a device via an access point (AP). An AP may be communicatively coupled to a gateway (such as a cable modem, fiber optic network device, a digital subscriber line (DSL) modem, or the like) to access a broadband network. The AP may provide a wireless network coverage area for one or more devices to access the broadband network via the AP. A network may include multiple APs capable of providing wireless network access. For example, a first AP can be communicatively coupled to the broadband network, and a second AP can wirelessly connect to the first AP while extending the wireless network coverage area of the network. The second AP may operate similar to the first AP by receiving, buffering, and then relaying data to and from the first AP and a device that is wirelessly associated with the second AP. It is possible to combine multiple APs such that each AP is in communication with at least one other AP to provide a larger wireless coverage area with network access to the broadband network. The wireless coverage area provided by an AP may utilize a 2.4 GHz frequency band, a 5 GHz frequency band, or both the 2.4 GHz frequency band and the 5 GHz frequency band. Within each frequency band, there may be different channels which an AP may utilize for the coverage area. Furthermore, overlapping coverage and multiple network topologies may provide various options (of AP, frequency band, or channel) for providing wireless service to a device in the network.

When a network includes two or more APs, a device may select and establish an association with one of the APs for connectivity to the network. Typically, the device may associate with an AP that has the highest signal strength as measured by the device. However, a device may not be aware of the topology of the network or the network conditions of the multiple APs. Enhanced AP selection techniques may improve service to the device.

### SUMMARY

The systems, methods, and devices of this disclosure each have several innovative aspects, no single one of which is solely responsible for the desirable attributes disclosed herein.

One innovative aspect of the subject matter described in this disclosure can be implemented by a first access point (AP) of a network. In some implementations, the first AP may be a Multi-AP Controller of the network. In other implementations, the technique described below may be performed by a Multi-AP Controller in coordination with the first AP. The first AP may determine that a wireless connection between the first AP and a device does not meet a quality of service (QoS) profile of the device. The QoS profile may include at least one of a capacity requirement and a delay requirement of the device. The first AP may estimate path performance metrics for each of a plurality of candidate paths between the device and a root AP of the network, wherein the path performance metrics include estimated path capacity and estimated path delay. The first AP may select a target path from among the plurality of candidate paths based, at least in part, on a comparison of the QoS profile of the device with the estimated path performance metrics, the target path comprising a plurality of links between a second AP and the root AP. The first AP may steer the device from the first AP to the second AP.

In some implementations, the device may be a client station (STA). Determining that the wireless connection does not meet the service profile of the device may include determining that the capacity requirement of the client station exceeds a first capacity of a first path from the first AP to the root AP, determining that the first path does not meet the delay requirement of the client station, or receiving an indication from the client station indicating that the QoS profile is not being met by the wireless connection.

In some implementations, the device may be a child AP. Determining that the wireless connection does not meet the service profile of the device may include determining that a current topology of the network does not meet a collective capacity requirement of a plurality of client stations associated with the child AP, or determining a chronic condition resulting from the child AP being unable to meet the collective capacity requirement of the plurality of client stations.

In some implementations, the first AP may obtain topology information of the network. The first AP may determine the plurality of candidate paths between the device and the root AP of the network based, at least in part, on the topology information.

In some implementations, the first AP may obtain performance information regarding a plurality of APs in the network. The performance information may include traffic flow parameters regarding one or more clients of the plurality of APs. The estimated path performance metrics may be based, at least in part, on the performance information regarding the plurality of APs.

In some implementations, the first AP may send a query to at least the second AP. The query may be for requesting the performance information from the second AP. The performance information describes at least one link in a candidate path between the root AP and the second AP. The first AP may receive a response from the second AP, the response including the performance information.

In some implementations, the first AP may send, to the root AP of the network, a request for the performance information. The first AP may receive a response from the root AP, the response including the performance information regarding the plurality of APs collected by the root AP.

In some implementations, the response includes topology information regarding a current topology of the network.

In some implementations, the first AP may obtain performance information. The performance information may include at least one member selected from the group consisting of: basic service set (BSS) information regarding a BSS at the second AP, the BSS information including channel utilization, number of wireless clients, number of child APs, link data rate, and scheduling behavior, overlapping BSS (OBSS) channel utilization, client capacity information for estimating available capacity for an additional client of the BSS, child AP capacity information for estimating available capacity for an additional child AP of the BSS, topology between the second AP and neighboring APs, hop count for each path from the second AP to the root AP, and delay metrics regarding each path from the second AP to the root AP.

In some implementations, estimating the path performance metrics for a candidate path includes at least one of: estimating an end-to-end path capacity for the candidate path between a serving AP of the candidate path and the root AP, estimating a hop count for the candidate path based, at least in part, on a quantity of intermediate APs in the candidate path, estimating an end-to-end delay between the serving AP of the candidate path and the root AP, and estimating a channel available airtime of a target BSS at the serving AP.

In some implementations, the estimated path capacity for a candidate path between a serving AP and the root AP may include an end-to-end path capacity. The first AP may estimate an end-to-end transmission schedule over a contention-based graph of the candidate path.

In some implementations, the first AP may estimate link capacities for a plurality of links in the candidate path. The first AP may estimate a lower bound of the end-to-end path capacity based, at least in part, the plurality of links being utilized sequentially during a plurality of contention free periods. The first AP may estimate an upper bound of the end-to-end path capacity based, at least in part, non-overlapping ones of the plurality of links being utilized concurrently during the plurality of contention free periods. The first AP may estimate the end-to-end path capacity based, at least in part, on the lower bound and the upper bound of the end-to-end path capacity

In some implementations, selecting the target path may include determining whether the client station has delay sensitive traffic. If the client station has delay sensitive traffic, the first AP may utilize a delay-focused selection technique to select the target path. If the client station does not have delay sensitive traffic, the first AP may utilize a capacity-focused selection technique to select the target path.

In some implementations, the first AP may utilize a capacity-focused selection technique. The first AP may determine a subset of the plurality of candidate paths that has an end-to-end path capacity higher than the capacity requirement of the client station. If the subset includes more than one candidate path, the first AP may select the target path that has a lowest end-to-end delay from among the subset. If the subset does not include more than one candidate path, the first AP may select the target path that has a highest end-to-end path capacity from among the plurality of candidate paths.

In some implementations, the first AP may utilize a delay-focused selection technique. The first AP may determine a subset of the plurality of candidate paths that has an end-to-end delay less than the delay requirement of the client station. If the subset includes more than one candidate path, the first AP may select the target path from among the subset based, at least in part, on an end-to-end capacity for each of the candidate paths in the subset. If the subset does not include more than one candidate path, the first AP may select the target path that has a lowest end-to-end delay from among the plurality of candidate paths.

In some implementations, if the subset of the candidate paths that have an end-to-end delay less than the delay requirement of the client station includes more than one candidate path that has an end-to-end capacity higher than the capacity requirement of the client station, the first AP may select the target path that has a lowest end-to-end delay from among the candidate paths that have an end-to-end capacity higher than the capacity requirement of the client station. If the subset of the candidate paths that have an end-to-end delay less than the delay requirement of the client station does not include more than one candidate path that has an end-to-end capacity higher than the capacity requirement of the client station, the first AP may select the target path that has a highest end-to-end capacity from among the subset.

In some implementations, if more than one of the plurality of candidate paths have an end-to-end capacity higher than the capacity requirement of the child AP, the first AP may select the target path that has a lowest end-to-end delay from among the candidate paths that have an end-to-end capacity higher than the capacity requirement of the child AP. Otherwise, the first AP may select the target path that has a highest end-to-end capacity from among the plurality of candidate paths.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 depicts a system diagram of an example network with multiple access points (APs) and serving AP selection for steering a device.

FIG. 2 depicts a system diagram of the example network with another example implementation.

FIG. 3 depicts a system diagram of the example network and serving AP selection in a topology change for a child AP.

FIG. 4 depicts a flowchart for serving AP selection in a network having multiple access points.

FIG. 5 depicts a message flow diagram of example messages in a system where a root AP manages a serving AP selection.

FIG. 6 depicts a message flow diagram of example messages in a system where a current serving AP manages a serving AP selection for steering a device.

FIG. 7 depicts a message flow diagram of example messages in a system where a child AP manages a serving AP selection for a topology change.

FIG. 8 depicts an example conceptual diagram of a message for sharing information used for serving AP selection.

FIG. 9 depicts a flowchart for serving AP selection used for steering a device.

FIG. 10 depicts a flowchart for serving AP selection used for a topology change.

FIG. 11 depicts an example conceptual diagram showing an estimation of an end-to-end capacity based on a contention-based graph of a candidate path.

FIG. 12 shows a block diagram of an example electronic device for implementing aspects of this disclosure.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The examples in this disclosure are based on wireless local area network (WLAN) communication according to the Institute of Electrical and Electronics Engineers (IEEE) 802.11 wireless standards. However, the described implementations may be implemented in any device, system or network that is capable of transmitting and receiving RF signals according to any of the wireless communication standards, including any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IOT) network, such as a system utilizing 3G, 4G or 5G, or further implementations thereof, technology.

A network in a home, apartment, business, or other area may include one or more access points (APs) that create a local area network. The local area network (LAN) (sometimes also referred to as a wireless local area network, or WLAN) may provide access to a broadband network. A gateway device, such as a central access point (CAP) or router, may provide access to the broadband network. For example, the gateway device can couple to the broadband network through a cable, a fiber optic, a powerline, or DSL network connection. Devices in the network can establish a wireless association (also referred to as a wireless link, wireless connection, or the like) with an AP to access the broadband network via the gateway device. For example, the wireless association may be in accordance with an association protocol of the AP. In some implementations, a network may include multiple APs. Typically, one of the APs will be referred to as a root AP, while other APs make path/routing selection using a logical topology between each of the other APs and the root AP. The root AP also may be a Multi-AP Controller of the network. A Multi-AP Controller is a logical entity that implements logic for controlling the operation of a network having multiple APs. A Multi-AP controller may or may not provide a wireless coverage area itself. For brevity, some examples of this description refer to a root AP (or RAP) which serves as the Multi-AP Controller and also provides wireless coverage. However, in some implementations, a Multi-AP Controller may not provide wireless connectivity and may be communicatively coupled to one or more APs in the network. The Multi-AP Controller may implement protocols for communicating with one or more APs in the network to manage wireless channel selection or client steering. Each AP in the network may have different hardware capabilities (such as 2.4 GHz, 5 GHz support, dual-band single radio, dual band dual concurrent radios (DBDC), or the like) that may provide different options for wireless coverage. Typically, each AP utilizes one or more channels within a frequency band. A channel may refer to a frequency (or range) used by the AP to communicate with devices that have a wireless association with the AP. Similarly, the devices utilize the channel to communicate (via a wireless association) with the AP. The IEEE 802.11 standards may define a Basic Services Set (BSS) as one antenna of the AP, the wireless channel configuration, and all devices that are associated with a particular channel. In some implementations, an AP may be equipped with more than one radio and may be capable of operating on more than one channel (such as a DBDC device). Each radio, channel, and associated STAs may be considered a separate BSS.

Typically, a device may select which AP (which may be referred to as a serving AP) to utilize from a plurality of APs. The serving AP selection may be based on signal strengths of wireless signals received from each of the plurality of APs. In addition to, or alternatively from, selecting an AP, a device also may select a frequency band. For example, the device may select a 2.4 GHz or 5 GHz frequency band from the frequencies bands available for communication between the device and the plurality of APs. A device may select a first AP and frequency band of the first AP based on the information available to the device. However, the first AP (or a Multi-AP Controller) may have access to more information regarding topology and performance of the APs in the network than is available to the device.

A first AP may optimize the network or improve service for the device by steering a device to a different AP (which would become the new serving AP for the device). Steering refers to any activity which causes the device to wirelessly associate with a second AP instead of maintaining the association with a first AP. Steering also may be referred to as a re-association activity, move, transfer, relocate, transition, switch, re-position, handover, or the like. Steering does not necessarily involve physical or geographic movement of the device. In this disclosure, there may be different types of devices utilizing a wireless association to a serving AP. For example, the device may be a client station (STA) or a child AP. A child AP (also referred to as a satellite AP, or SAP) is any access point that receives network access to the broadband network via one or more upstream serving APs. Because the child AP also may have client stations associated to a BSS of the child AP, steering a child AP also may be referred to as a topology change in the network.

There may be various reasons for steering the device. For example, the device may be steered to a different AP to perform load balancing in the network. Other factors or conditions for steering a device may include backhaul performance, network topology, performance (throughput, bandwidth, latency, errors, jitter, and the like), locations of newly connected devices, intensity of communication between devices and an AP (such as bandwidth, bursting, types of traffic, and the like), assigned priorities of the devices, a change in quality of service (QoS) or other performance requirement of the device, or a BSS capability of the AP may change.

In accordance with this disclosure, selection of a serving AP for a device may be based on a QoS profile of the device (which may be a client station or a child AP). For example, the QoS profile (which also may be referred to as a quality of service, QoS, requirement) may be a capacity requirement (which also may be referred to as a traffic demand) or a delay requirement associated with a traffic flow of the device. In some implementations, the capacity requirement may represent a minimum amount of capacity (through a path to the root AP or gateway) that is needed to service the device. In some implementations, the delay requirement may represent a maximum amount of delay (through a path to the root AP or gateway) that is acceptable for the QoS profile. In this disclosure, a delay may be quantified as a time period or may be quantified as a hop count. A hop count refers to the number of links (between serving APs, intermediate APs, and the root AP) that are used in a path.

Steering a device (or performing a topology change) may improve service to the device. To accommodate the QoS profile, a serving AP selection unit (in an AP of the network) may consider the topology of the network and performance information for various APs of the network. The topology and performance information can be used to estimate end-to-end path capacity and end-to-end path delay for each of a plurality of candidate paths. The selection of a target path may be based on the end-to-end path capacity or end-to-end path delay for the plurality of candidate paths. Depending on whether the traffic associated with the device is delay sensitive, the serving AP selection unit may use a capacity-focused selection technique or a delay-focused selection technique. Furthermore, operations of the serving AP selection unit may be performed by a current serving AP, a child AP, a neighboring AP, a root AP, or a Multi-AP Controller. The target path includes a path from a target serving AP to the root AP. Steering the device to the target serving AP will cause the device to utilize the target path which has been selected in view of the QoS profile of the device.

Particular implementations of the subject matter described in this disclosure can be implemented to realize one or more of the following potential advantages. A first AP may obtain topology and performance information for various APs of the network. The information can be used to select an optimal path for a device based on a QoS profile of the device. Steering a device to wirelessly associate with a particular AP may improve service for the device or may improve operation of the network.

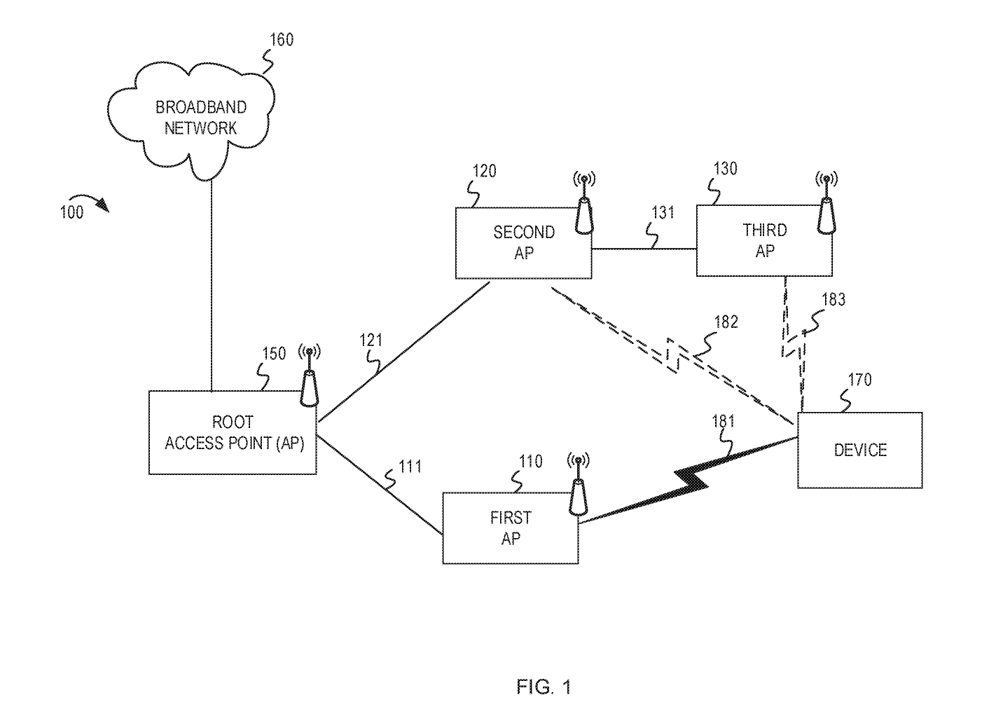

FIG. 1 depicts a system diagram of an example network with multiple APs and serving AP selection for steering a device. The network 100 includes a root access point (root AP, or RAP) 150 that serves as a Multi-AP Controller for the network 100. In FIG. 1, the RAP 150 also provides access to a broadband network 160. For example, the RAP 150 may be a central access point or router which is communicatively coupled to the broadband network 160. The root AP 150 may be separate or co-located with a gateway device (not shown). For example, the gateway device can couple to the broadband network through a cable, a fiber optic, a powerline, or DSL network connection. The network also includes multiple APs, including a first a first AP 110, a second AP 120, and a third AP 130. In some implementations (as shown in FIG. 1), the root AP 150 is independent and separate from the multiple APs. In other implementations, one of the multiple APs may be collocated with the root AP 150 or may be part of the same apparatus. In this disclosure, the term AP refers to any device that provides wireless access to a network, including access points and range extenders (REs).

The first AP 110 may have a backhaul channel 111 to the root AP 150. The second AP 120 may have a backhaul channel 121 to the root AP 150. The third AP 130 may have a backhaul channel 131 to the second AP 120. In this arrangement, the third AP 130 may be referred to as a child AP of the second AP 120. Similarly, the second AP 120 and first AP 110 may be referred to as child APs of the root AP 150. For example, as shown in FIG. 1, the third AP 130 obtains access to the broadband network 160 via the second AP 120 and root AP 150. A child AP utilizes a backhaul channel to access an upstream AP. The backhaul channels 111, 121, 131 may be wired, wireless, or a combination of wireless and wired links.

Each of the multiple APs may be associated with a wireless coverage area (not shown). The wireless coverage areas may overlap, and a device 170 may be within the wireless coverage area of more than one AP. The network 100 includes a device 170 (such as a laptop, a computer, a sensor, a camera, a thermostat, a mobile station, a wireless device, a smartphone, etc.) that is initially associated (shown as wireless association 181) with the first AP 110. In the example in FIG. 1, the device 170 may be a STA. In other examples, the device 170 may be a child AP that has wireless associations with other STAs. Although FIG. 1 depicts one device (device 170) accessing a wireless channel utilized by the APs 110, 120, and 130, other devices may be present.

When a network includes two or more APs, a device may select an AP and a frequency band using an AP selection technique at the device. For example, the device may initially associate with an AP that has the strongest signal. Once associated with a particular AP, the device may remain associated with that AP until that AP's signal strength becomes weak. As the device moves to another location, the device can disassociate from that AP, and associate with another AP that has a stronger signal strength. In FIG. 1, although the device 170 may initially be associated with the first AP 110, the first AP 110 may not be the optimal access point to provide services to the device 170. Furthermore, the device 170 may not be aware of the topology of the network in which one or more APs may be chained in various configurations to form an extended coverage area. The topology and backhaul utilization associated with one or more of the APs may impact the quality of service that can be provided to the device 170.

Considering the scenario depicted in FIG. 1, the device 170 may be within range of the first AP 110 (via the first fronthaul channel 181) or may alternatively utilize fronthaul channels 182, 183 to the second AP 120 or the third AP 130, respectively. However, the device 170 may not know (or have access to) information about the network topology, backhaul utilization, or service capabilities associated with each of the APs. In some implementations, the APs 110, 120, and 130 may assist in the identification of conditions in which the device would be better served in the network by steering the device from the first AP 110 to the second AP 120 or the third AP 130. For example, the APs may exchange information about channel utilization, network traffic flow, backhaul network conditions, network bandwidth availability, or the like. The backhaul network conditions may be based on a multi-hop path involving more than one AP that are wirelessly connected to each other (such as a chain) and to the RAP 150. The APs may exchange information regarding wireless capacity to serve the device 170 based on the capabilities of the AP or the device 170. In some implementations, the APs may exchange information about the traffic flows for various devices connected to the AP. Using the collected information, the first AP 110 may estimate the performance that would be experienced by the device 170 using either the second AP 120 or the third AP 130. Selection of the target AP (to become a new serving AP) for the device 170 may be based on a comparison of estimated performance for each of the APs 110, 120, and 130.

In the example in FIG. 1, the first AP 110 may determine to steer the device 170 to the second AP 120. The first AP 110 may determine to drop the first fronthaul channel 181 to the device 170 and cause the device 170 to establish a wireless association over a second fronthaul channel 182 to the second AP 120. For example, the second AP 120 may provide better network performance (via the second fronthaul channel 182) to the device 170 than the first AP 110 (via the first fronthaul channel 181). As an example, the second AP 120 may have better conditions to satisfy the QoS profile (as compared to the first AP 110). The better conditions may include less wireless utilization, a different frequency band, less backhaul latency, or the like. As another example, second AP 120 may provide a 5 GHz frequency band for communication with the device 170 which may be better suited for the type of traffic for the device 170 than a 2.4 GHz frequency band used by the first AP 110. In some implementations, the root AP 150 may manage which devices associate with the first AP 110, second AP 120, and third AP 130 based on the type of traffic used by each device. As an example, multimedia or low latency communication may be directed to the first AP 110, while best effort latency or reliable delivery communication may be directed to the second AP 120, or vice versa.

In some implementations, the first AP 110 may determine compatibility regarding wireless access technologies utilized by the device 170 and available at the multiple APs. Different wireless access technologies might be defined in standard specifications. The wireless access technologies may have different physical communication rates or protocols. The first AP 110 may utilize a first wireless access technology utilized by a first set of devices and the second AP 120 may utilize a second wireless access technology compatible with a second set of devices. If a device supports both the first wireless access technology and the second wireless access technology, a selection of the AP may be based on physical communication rates available from the wireless access technologies. The first AP 110 may determine to steer the device 170 to the second AP 120 associated with a faster effective physical communication rate than the first AP 110. The first AP 110 may command or steer the device 170 to utilize the second AP 120 rather than the first AP 110. In addition to steering the device 170 to a particular AP, the first AP 110 may select a particular frequency band (such as 2.4 GHz or 5 GHz) and channel, and steer the device 170 to utilize the selected frequency band and channel.

There may be various reasons for steering the device 170. In one example, one or more fronthaul associations for one or more devices may be changed concurrently to improve the overall performance of the network 100. For example, the root AP 150 may have the device 170 transition from the first AP 110 to the second AP 120 to improve overall throughput through the network 100. In some implementations, the device 170 may be steered to a different AP to perform load balancing on the network 100. A decision to steer the device 170 may be made to accommodate a change in traffic demand (such as a change in the capacity requirement), quality of service (QoS) or other performance requirement (such as a change in the delay requirement) of the device 170. The QoS profile of the device 170 may include an increase or decrease to a capacity requirement or delay requirement, triggering a potential reason to perform a serving AP selection.

In some implementations, the steering decision may be based on a combination of fronthaul and backhaul conditions. For example, a path may include fronthaul and backhaul channels that self-contend. The capacity of the path may take into account the fronthaul and backhaul contention timing or utilization constraints. The steering decision may be based on an application type. For example, a gaming application may perform better with a lower number of hops between the device and the root AP (or the gateway device). The types of traffic flows being used in the network may impact the steering decision. Thus, the APs may exchange information about what traffic flows are being used at each AP.

In some implementations, an AP (or Multi-AP Controller) may maintain a history of steering decisions for client devices in the network. For example, if a previous steering decision has been made based on a QoS profile, then the AP (or Multi-AP Controller) may store a history of the previous steering decision. The history may be used to determine of which client devices are more likely to have a particular traffic type or QoS profile. An AP may preemptively steer a client device to a particular AP (such as one with fewer hops to the root AP) if the client device has previously been steered based on the QoS profile.

There are various techniques which can be used to steer the device 170 to a particular AP, frequency band, or channel. For example, steering the device 170 may include attempting at least one re-association activities steer the device 170 to the second AP 120. For example, in IEEE 802.11v or other protocols, the first AP may simply ask the device to re-associate to the second AP. An IEEE 802.11v configuration message may include a list of one or more other APs (for example, including the second AP 120) as a suggestion to the device to re-associate to another AP. However, if the device does not support IEEE 802.11v protocols or chooses to ignore the suggestion, the first AP 110 may use another technique to steer the device 170. For example, the first AP 110 may send a disassociation message to the device 170 or the first AP 110 may block traffic (at least one incoming packet) for the device 170.

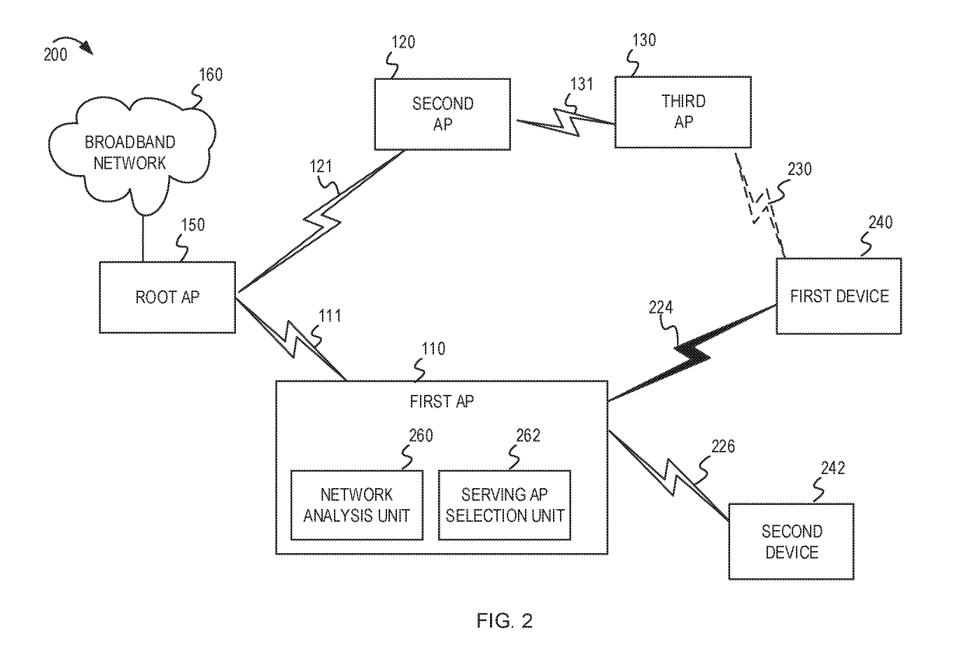

FIG. 2 depicts a system diagram of the example network with another example implementation. In FIG. 2, the APs 110, 120, and 130 can be used to extend the coverage of the network 200. In the example implementation of FIG. 2, the APs 110, 120, and 130 are configured as dual band, dual concurrent (DBDC) wireless access points. A DBDC device can include two transceivers and can operate on two different frequency bands independently and simultaneously. For example, a first transceiver can operate in the 2.4 GHz frequency band and a second transceiver can operate in the 5 GHz frequency band. The two transceivers can be linked at the DBDC device such that data can be communicated between the transceivers. When using DBDC devices, additional network data pathway selections are possible. Furthermore, in some implementations, a network (such as a hybrid network) can support both wired and wireless communication technologies, multiple wired communication technologies, or multiple wireless communication technologies. For example, the root AP and/or the APs 110, 120, and 130 can support both IEEE 802.11 and powerline communication protocols. In other examples, the root AP and/or the APs 110, 120, and 130 can support a combination of IEEE 802.11 and powerline communication protocols, a combination of IEEE 802.11 and coaxial cable (Coax) based communication protocols, a combination of long-term evolution (LTE) and IEEE 802.11 communication protocols, a combination of IEEE 802.11 and Bluetooth communication protocols, and various other suitable combinations. Thus, the network data pathways in the hybrid network can include wired and wireless communication technologies. In some implementations, the root AP 150 and the APs 110, 120, and 130 can comply with other wireless specifications, such as a ZigBee® specification, or a cellular radio specification or any other technically feasible wireless protocol. The link between the root AP 150 and the broadband network 160 can be referred to as a broadband link. The broadband link can provide at least a portion of a data pathway to another network (such as a communication service provider network, Internet, etc.). The broadband link of the root AP 150 can be a wireless, a wired (such as through an Ethernet or powerline connection), or a hybrid link. The serving AP selection in this disclosure can be used with DBDC wireless devices similarly as with non-DBDC wireless devices. While some implementations in this disclosure are described in relation to one channel per device (such as, the root AP 150 and the APs 110, 120, and 130), the implementations are not so limited.

In FIG. 2, the network 200 includes the root AP 150, the first AP 110, the second AP 120, and the third AP 130, similar to the corresponding elements described in FIG. 1. The network 200 also includes a first device 240 and a second device 242. In the example network 200, the root AP 150 may include routing connections or capability between the network 200 and the broadband network 160. Since the root AP 150 and the APs 110, 120, and 130 are DBDC capable, the root AP 150 and the APs 110, 120, and 130 each include two independent transceivers (not shown). The APs 110, 120, and 130 can be positioned throughout a desired coverage area of the network 200. As shown in FIG. 2, the second AP 120 is coupled to the root AP 150 through backhaul channel 121 (depicted as a wireless backhaul channel in the example network 200). Similarly, the third AP 130 is coupled to second AP 120 through backhaul channel 131 and the first AP 110 is coupled to root AP 150 through backhaul channel 111. Each link in the diagram can represent a particular frequency band (2.4 GHz or 5 GHz, for example) and a particular channel within that frequency band that can be used to carry wireless data between two devices. The frequency and channel selection can enable the root AP 150 and APs 110, 120, and 130 to communicate through links that do not interfere with other links in the network 200. For example, the root AP 150 can transmit and receive data through a first transceiver in either the 2.4 GHz band or 5 GHz band (or both) for the backhaul channel 111. The root AP 150 can transmit and receive data through a second transceiver in the 2.4 GHz band or 5 GHz band (or both) for the backhaul channel 121. In this manner, communications between the root AP 150 and the first AP 110 can have little or no effect on communications between the root AP 150 and the second AP 120.

However, the configuration flexibility of a DBDC wireless device (such as the root AP 150 and the APs 110, 120, and 130), can increase the complexity associated with selecting an AP, frequency band, and channel to use for wireless associations by the devices 240, 242. The first device 240 is initially coupled to the first AP 110 through fronthaul channel 224 and the second device 242 is coupled to the first AP 110 through fronthaul channel 226. As depicted, the backhaul channel 111 is the backhaul channel for the first AP 110 to access the broadband network 160 via the root AP 150. The other links (such as the fronthaul channel 224 and the fronthaul channel 226) on the AP 110 can be referred to as fronthaul channels. In a similar manner, the fronthaul channel 224 and the fronthaul channel 226 can serve other APs or stations (not shown). The backhaul channel 131 can be the backhaul channel for the third AP 130. To optimize service for the first device 240, the first AP 110 (or root AP 150) may steer the first device 240 to a different fronthaul channel at a different AP (such as fronthaul channel 230 at the third AP 130). For example, the first AP 110 may determine that the estimated performance at the third AP (based on backhaul channel conditions for backhaul channels 121, 131 and any fronthaul channels of the third AP 130) would be better than the estimated performance at either the second AP 120 or first AP 110.

In the example of FIG. 2, the first AP 110 includes a network analysis unit 260 to obtain topology information about the network and performance information regarding the other APs in the network 200. The first AP 110 also includes a serving AP selection unit 262 to select a new serving AP and steer the first device 240 based on the information collected by the network analysis unit 260. The network analysis unit 260 can determine various channel conditions, wireless device configurations, and wireless device capabilities with respect to the components of the network 200 (such as the root AP 150, devices 240, 242 and/or APs 110, 120, and 130). For example, the network analysis unit 260 can determine a topology of the network, including backhaul channels used by other APs to communicate to the root AP 150. The first AP 110 may select a target AP (such as the third AP 130 in the example of FIG. 2) as the serving AP for the first device 240 based at least in part on path capacity and delay of a path from the target AP to the root AP. The selection of the target path may take into account the QoS profile (such as the traffic type, capacity requirement, and delay requirement) of the first device 240. For example, the first AP 110 may compare the estimated performance of candidate paths from each of the APs 110, 120, and 130 to the root AP 150. The estimated performance may be based on the backhaul channel utilization and/or the available airtime estimate for each fronthaul channel available at APs 110, 120, and 130. As described above, the root AP 150, the APs 110, 120, and 130, and the devices 240, 242 can be DBDC devices capable of operating within two frequency bands. The network analysis unit 260 can determine a current configuration and capability of the DBDC devices with respect to the operating frequency bands and links. For example, the network analysis unit 260 can poll the root AP 150, the APs 110, 120, and 130, and the devices 240, 242 to determine their respective configurations and capabilities. The network analysis unit 260 also can determine the configuration and capabilities of non-DBDC devices.

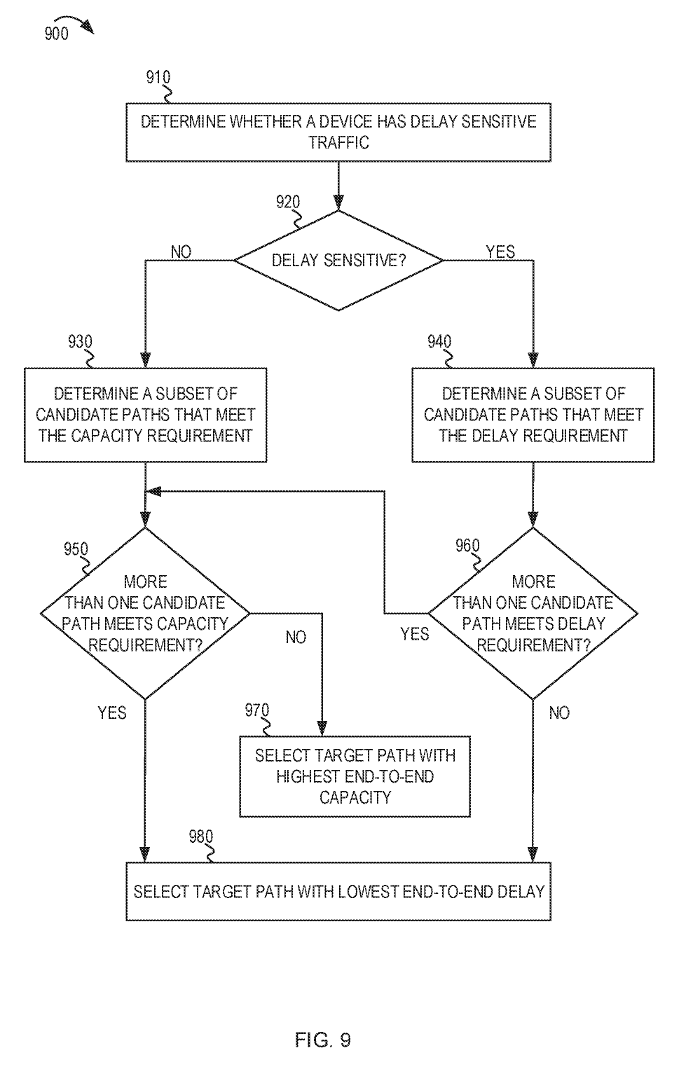

The serving AP selection unit 262 may compare the estimated performance for the candidate paths with the QoS profile of the first device 240 when selecting an appropriate target AP. The serving AP selection unit 262 may be capable of using various techniques that take into account the type of traffic being sent to or received by the device. For example, the serving AP selection unit 262 may determine that the first device 240 has delay sensitive traffic and may utilize a delay-focused selection technique for selecting the target path. If the first device 240 does not have delay sensitive traffic, the serving AP selection unit 262 may use a capacity-focused selection technique for selecting the target AP. A more detailed description of example techniques (including the capacity-focused selection technique and the delay-focused selection technique) is included in the description of FIG. 9.

In some implementations, the serving AP selection unit 262 may estimate the expected performance for each of a plurality of candidate paths available between the APs 110, 120, and 130 and the root AP 150. For example, the serving AP selection unit 262 may estimate an end-to-end capacity for each candidate path associated with more candidate APs (such as APs 120 and 130). The serving AP selection unit 262 may estimate an end-to-end delay for each candidate path. In this disclosure, a delay may be quantified as a time period or may be quantified as a hop count. A hop count refers to the number of links (between serving APs, intermediate APs, and the root AP) that are used in a path. A first path having a higher hop count may be considered as having a higher delay than a second path having a lower hop count.

In the example in FIG. 2, a new path from the third AP 130 to the root AP 150 (using the backhaul channel 121, the second AP 120 as an intermediate AP, and backhaul channel 131) may have a greater end-to-end capacity (or a lower end-to-end delay) than an existing path from the first AP 110 to the root AP 150 (using the backhaul channel 111). Therefore, the target path (from the third AP 130 to the root AP 150) may be selected from among candidate paths in the network that satisfy the QoS profile of the device. In this example, the serving AP selection unit 262 would select the third AP 130 as the new serving AP for handling a wireless association from the first device 240. After selecting the third AP 130, the serving AP selection unit 262 may steer the first device 240 to the third AP 130. As described above, steering may include sending a message to the first device 240 (or other re-association technique) to cause the first device 240 to re-associate with the third AP 130.

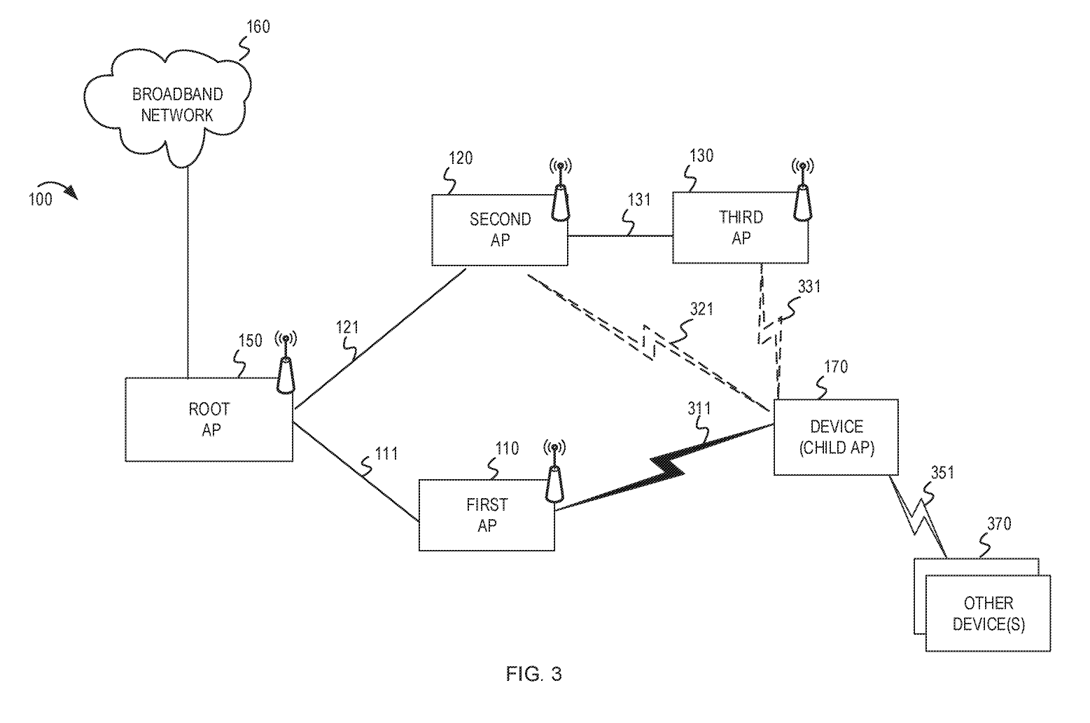

FIG. 3 depicts a system diagram of the example network and serving AP selection in a topology change for a child AP. In FIG. 3, a network 300 includes a root AP 150 communicatively coupled to a broadband network 160. The network 300 includes the first AP 110, the second AP 120, and the third AP 130 as described in FIG. 1. The first AP 110 is coupled by backhaul channel 111 to the root AP 150. The second AP 120 is coupled by backhaul channel 121 to the root AP 150. The third AP 130 is coupled by backhaul channel 131 to the second AP 120. The backhaul channels 111, 121 and 131 may be wired or wireless backhaul channels. The device 170 is a child AP in FIG. 3. The device 170 is coupled by a wireless backhaul channel 311 to the first AP 110. For example, the wireless backhaul channel 311 may be wirelessly associated to a fronthaul channel of the first AP 110. The device 170 also has one or more wireless associations via a fronthaul channel 351 to one or more other device(s) 370.

Initially, the first AP 110 is the serving AP for the device 170 (child AP). In an example scenario, either of the root AP 150, the first AP 110, a Multi-AP Controller (not shown), or the device 170 may determine that a different serving AP may improve service to the device 170 or to the other device(s) 370. For example, the wireless backhaul channel 311 may not meet the QoS profile (such as a collective capacity requirement) associated with the device 170 and the other device(s) 370. The wireless backhaul channel 311 may experience a chronic condition of repeatedly becoming congested. One possibility, depicted in FIG. 3, is that the root AP 150 may steer the device 170 to utilize a different backhaul channel via one of the other APs (such as the second AP 120 or the third AP 130). The root AP 150 may determine that steering the device 170 would optimize the service provided to the other device(s) 370. For example, the backhaul channel 321 (to the second AP 120) may be lightly loaded. In the example scenario in FIG. 3, the device 170 may be steered to utilize a new backhaul channel 321 to the second AP 120 or a new backhaul channel 331 to the third AP 130. Selection of the serving AP (either the first AP 110, the second AP 120, or the third AP 130) may be made based the QoS profile of the device 170 (with consideration for its downstream devices). For example, in a capacity-focused selection technique, the serving AP may be selected using a first criteria based on estimated end-to-end path capacities for each of the paths from the first AP 110, the second AP 120, or the third AP 130 to the root AP 150. As described below, the end-to-end capacity may be based on a long-term estimate, such as an average of previous estimates or a rolling average of estimates. In some implementations, the end-to-end path capacity may be estimated by considering the topology of the network and utilization of contention free periods for various links in the path. It also may be possible to use a delay-focused selection technique to consider whether certain paths can meet the delay requirement of the device 170 (and its downstream devices).

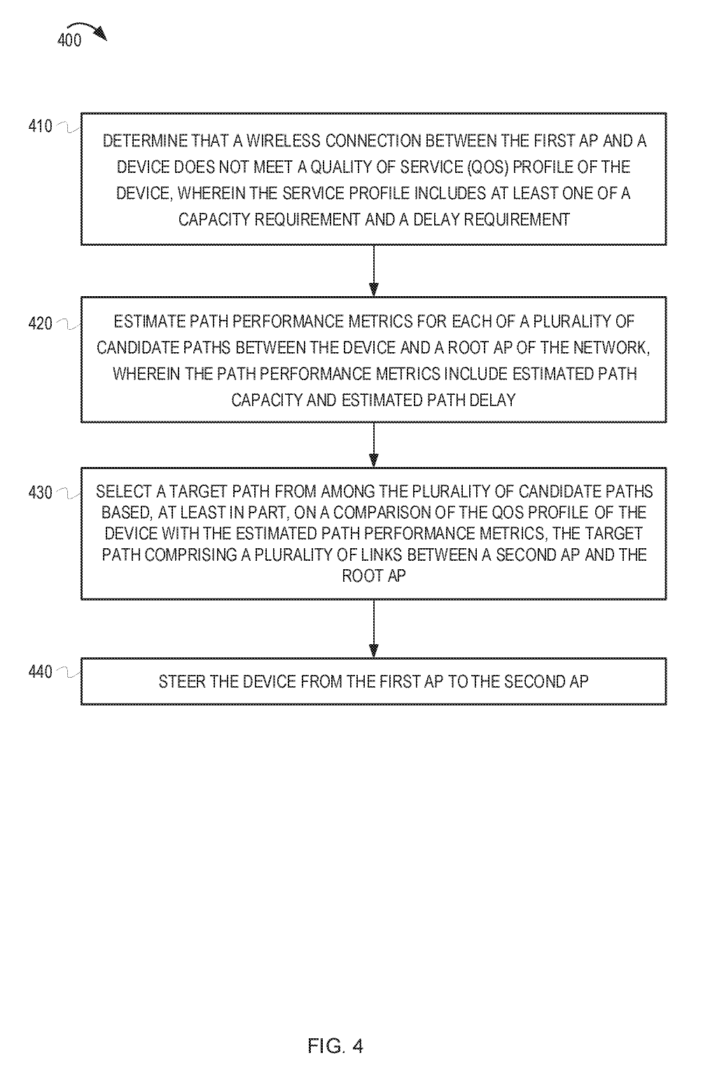

FIG. 4 depicts a flowchart for serving AP selection in a network having multiple access points. Alternatively, the flowchart may be performed by a Multi-AP Controller of the network. The flowchart 400 begins at block 410. At block 410, a first AP may determine that a wireless connection between the first AP and a device does not meet a QoS profile of the device. The QoS profile may include at least one of a capacity requirement and a delay requirement of the device. For example, if the device is a client station, the first AP may determine that the capacity requirement of the client station exceeds a first capacity of a first path from the first AP to the root AP, may determine that the first path does not meet the delay requirement of the client station, or may receive an indication from the client station indicating that the QoS profile is not being met by the wireless connection. Alternatively, if the device is a child AP, the first AP may determine that a current topology of the network does not meet the collective capacity requirement of a plurality of client stations associated with the child AP, or determine that a chronic condition exists resulting from the child AP being unable to meet the collective capacity requirement of the plurality of client stations.

At block 420, the first AP may estimate path performance metrics for each of a plurality of candidate paths between the device and a root AP of the network. The path performance metrics may include estimated path capacity and estimated path delay. For example, the path performance metrics may include an end-to-end path capacity and an end-to-end path delay for a candidate path between a serving AP and the root AP.

At block 430, the first AP may select a target path from among the plurality of candidate paths based, at least in part, on a comparison of the QoS profile of the device with the estimated path performance metrics. The target path is made up from a plurality of links between a second AP and the root AP. In some implementations, the selection of the target path may depend on whether or not the device has delay sensitive traffic. For example, the delay-focused selection technique or capacity-focused selection technique described in FIG. 9 may be used depending on whether the device has delay sensitive traffic.

At block 440, the first AP may steer the device from the first AP to the second AP, such that the device will utilize the target path via the second AP. For example, the first AP may cause the device to re-associate to the second AP by sending a configuration parameter to the device identifying the second AP, sending a disassociation message to the device, blocking at least one incoming packet from the device, or any combination thereof.

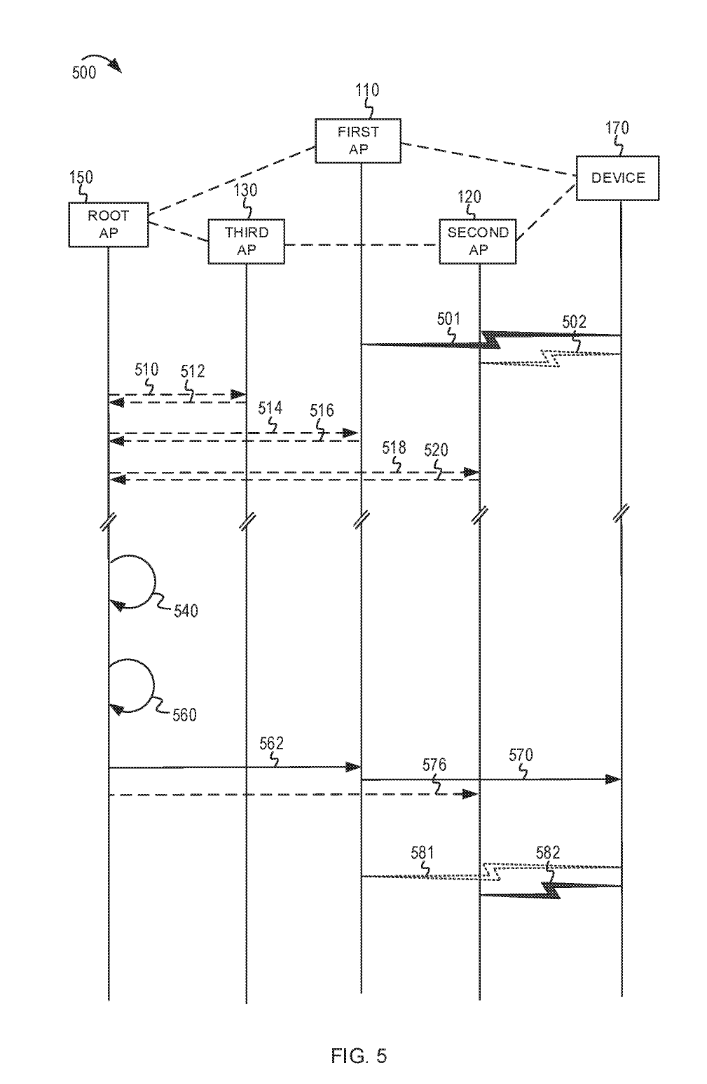

The serving AP selection techniques in this disclosure may be performed by a root AP, a current serving AP, a neighboring AP (neighboring the current serving AP), or a child AP. FIGS. 5-7 describe various implementations where the serving AP selection is performed at different APs in the network.

FIG. 5 depicts a message flow diagram of example messages in a system where a root AP manages a serving AP selection. The diagram 500 describes example messages exchanged between a root AP 150, a first AP 110, a second AP 120, a third AP 130, and a device 170. Prior to steering the device 170, the device 170 has a wireless association (shown as a used wireless signal 501) with the first AP 110. The device 170 also may be within a coverage area associated with the second AP 120 (shown as an unused wireless signal 502). The root AP 150 may periodically obtain performance information (such as fronthaul channel utilization and backhaul channel utilization) regarding one or more APs in the network. For example, the root AP 150 may send a message (shown as arrow 510) to request the performance information from the third AP 130. The root AP 150 may receive a response (shown as arrow 512) from the third AP 130. Similarly, at 514 and 518, the root AP 150 may poll the first AP 110 and second AP 120, respectively. The responses, at 512, 516, and 520, may include information that can be used to evaluate candidate paths in the network.

In the example of FIG. 5, the root AP 150 may poll each of the APs 110, 120, and 130 to obtain the information needed to determine a topology of the network, to determine candidate paths between the APs and the root AP 150, and to estimate the performance (such as capacity or delay) associated with each candidate path. Examples of information collected from each AP may include BSS information regarding a BSS at the polled AP, the BSS information including channel utilization, number of wireless clients, number of child APs, link data rate, and scheduling behavior. The performance information may include channel utilization for an overlapping BSS, client capacity information for estimating available capacity for an additional client of the BSS, child AP capacity information for estimating available capacity for an additional child AP of the BSS, topology between the polled AP and neighboring APs, hop count for each path from the polled AP to the root AP, or delay metrics regarding each path from the polled AP to the root AP. Although describes as polling messages and responses in FIG. 5, in other examples, the APs 110, 120, and 130 may periodically report the information to the root AP 150.

At 540, the root AP 150 may determine that a QoS profile of the device 170 is not being met. For example, the device 170 may require more capacity than is available using the used wireless signal 501 and the path from the first AP 110 to the root AP 150. In another example, the device 170 may be sending or receiving delay sensitive traffic and the delay using the path from first AP 110 to root AP 150 may be greater than a delay requirement for the traffic.

At 560, the root AP 150 may select a new serving AP for the device 170 (for example, using the delay-focused selection technique or capacity-focused selection technique described in FIG. 9). In the example of FIG. 5, the root AP 150 selects the second AP 120 as the new serving AP. For example, even though the second AP 120 may have an intermediate AP between the second AP 120 and the root AP 150, the path between the second AP 120 and the root AP 150 may have a greater capacity or lower delay. At 562, the root AP 150 may inform (or instruct, command, or suggest) the first AP 110 to steer the device 170 to the second AP 120. At 570, the first AP 110 may steer the device 170 to the second AP 120. In some implementations, the root AP 150 may coordinate the steering by informing the second AP 120 regarding the serving AP selection so that the second AP 120 is prepared to accept a wireless association from the device 170.

After the steering, the device 170 has a wireless association (shown as a used wireless signal 582) with the second AP 120. The device 170 may discontinue using the first AP 110 (shown as an unused wireless signal 581).

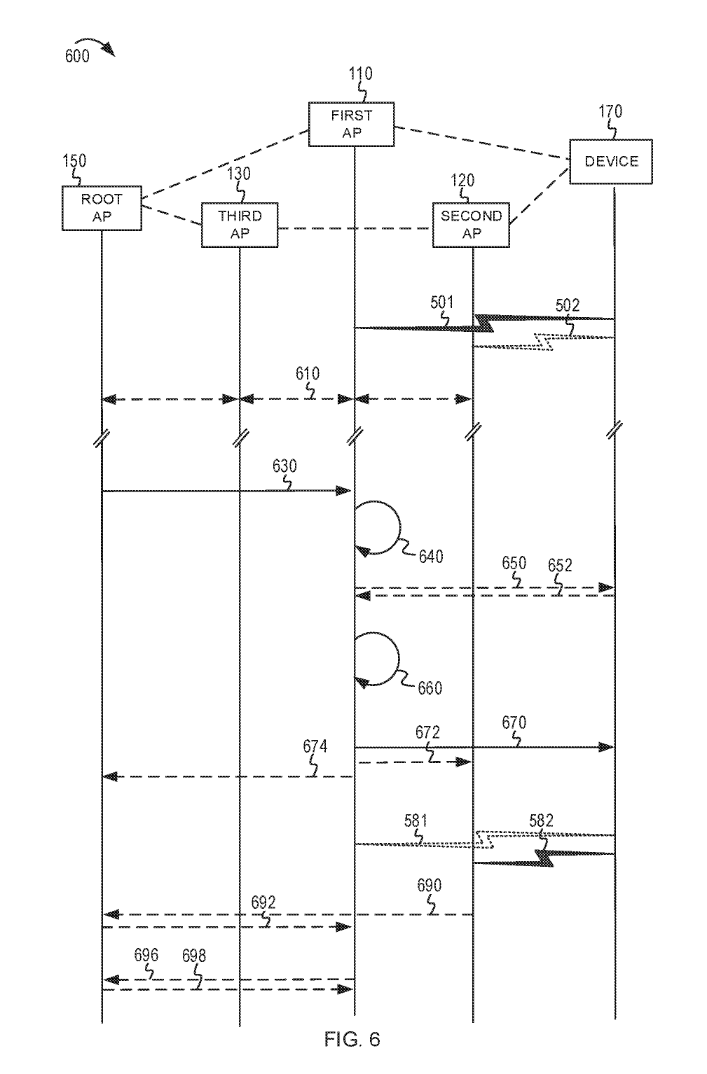

FIG. 6 depicts a message flow diagram of example messages in a system where a current serving AP manages a serving AP selection for steering a device. The diagram 600 describes example messages exchanged between a root AP 150, a first AP 110, a second AP 120, a third AP 130, and a device 170. Prior to steering the device 170, the device 170 has a wireless association (shown as a used wireless signal 501) with the first AP 110. The device 170 also may be within a coverage area associated with the second AP 120 (shown as an unused wireless signal 502). FIG. 6 is similar to corresponding operations in FIG. 5, except that the current serving AP (the first AP 110) may manage the serving AP selection.

At 610, the first AP 110 may obtain topology and performance information regarding one or more other APs in the network. There may be a variety of ways for the first AP 110 to obtain the information. For brevity, the message(s) to obtain the topology and performance information is shown collectively at arrows 610. In some implementations, the first AP 110 may poll each of the other APs (as described with messages 510, 514, and 518 in FIG. 5). In another implementation, the root AP 150 may collect the information from multiple APs and send the collected information to the first AP 110. For example, the first AP 110 may send a message to request the topology and performance information from the root AP 150. The first AP 110 may receive a response having the collected information from the root AP 150. If the root AP 150 does not already have the information collected, the root AP 150 may send messages (not shown) to request the information from one or more of the APs in the network.

At 630, the root AP 150 may send an indication to the first AP 110 that steering is allowed (such as a steering allowed message). For example, the root AP 150 may control a schedule for steering in the network to prevent multiple APs from steering devices concurrently—especially if steering by one AP may impact the performance estimation by another AP considering steering. In some implementations, the message at 630 may include channel condition information for each of the BSSs along the paths from the candidate APs to the root AP 150.

At 650, the first AP 110 may send a measurement request message to the device 170. For example, the message may be formatted similar to IEEE 802.11k measurement request message to request measurement data from the perspective of the device 170. At 652, the device 170 may respond with the measurement data. For example, the device 170 may reply with an IEEE 802.11k measurement response message.

At 660, the first AP 110 may select a new serving AP for the device 170. For example, the first AP 110 may use the delay-focused selection technique or the capacity-focused selection technique described in FIG. 9, depending on the type of traffic being sent to or received by the device 170. In the example of FIG. 6, the first AP 110 selects the second AP 120 as the new serving AP. At 670, the first AP 110 may steer the device 170 to the second AP 120. In some implementations, the first AP 110 may inform (shown as arrow 672) the second AP 120 of the serving AP selection so that the second AP 120 will be prepared to accept the wireless association from the device 170. In some implementations, the first AP 110 may inform (shown as arrow 674) the root AP 150 of the serving AP selection.

After the steering, the device 170 has a wireless association (shown as a used wireless signal 582) with the second AP 120. The device 170 may discontinue using the first AP 110 (shown as an unused wireless signal 581).

In some implementations, the second AP 120 may send a notification (shown at arrow 690) to the root AP 150 to indicate that the device 170 has successfully been steered to the second AP 120. For example, if the device 170 is a child AP, the message at arrow 690 may be a topology change notification. The root AP 150 also may send a topology change notification to the first AP 110 (shown at arrow 692) or to other APs in the network (not shown).

At 696, the first AP 110 may send a steering finished message to the root AP 150. Doing so may enable the root AP 150 to proceed with a steering allowed message (not shown) to another AP in the network. The root AP 150 may acknowledge the steering finished message with a steering finished response message (shown at 698).

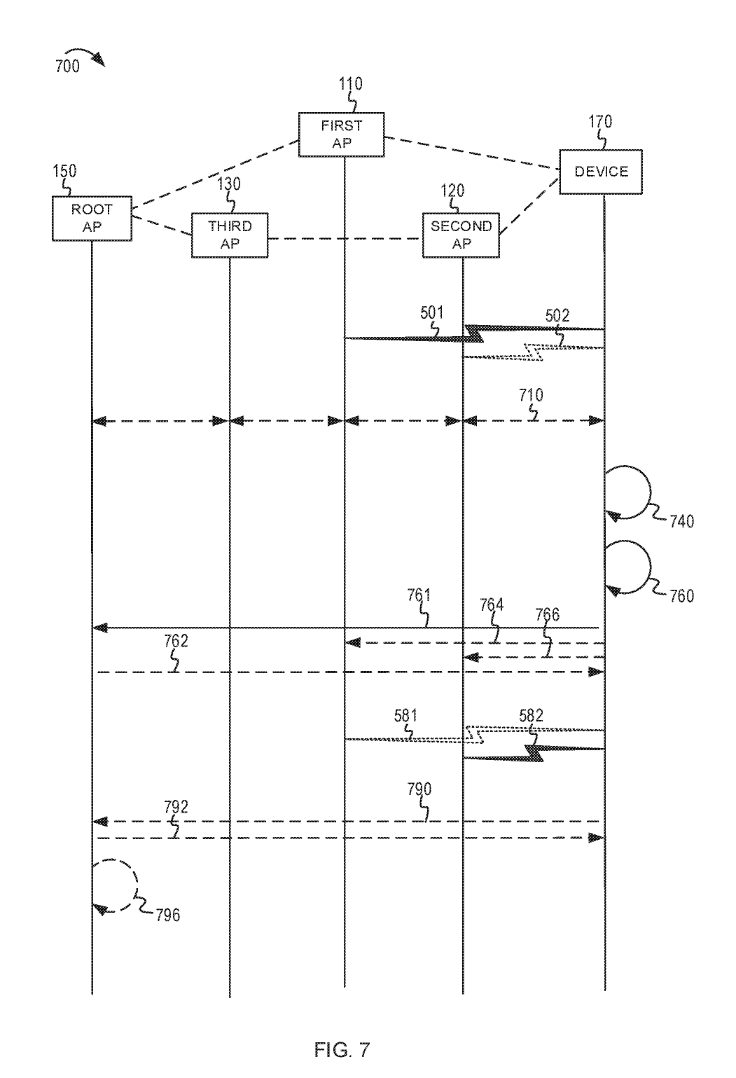

FIG. 7 depicts a message flow diagram of example messages in a system where a child AP manages a serving AP selection for a topology change. The diagram 700 describes example messages exchanged between a root AP 150, a first AP 110, a second AP 120, a third AP 130, and a device 170. Prior to steering the device 170, the device 170 has a wireless association (shown as a used wireless signal 501) with the first AP 110. The device 170 also may be within a coverage area associated with the second AP 120 (shown as an unused wireless signal 502). FIG. 7 is similar to corresponding operations in FIG. 5, except that the device 170 is a child AP, and the child AP may manage the serving AP selection.

At 710, the device 170 may obtain topology and performance information regarding one or more other APs in the network. Similar to 610 in FIG. 6, the device 170 may utilize a variety of ways to obtain the information, including (but not limited to) exchanging messages with the other APs, polling the other APs, or obtaining the information collected by the root AP 150.

At 740, the device 170 may determine that a QoS profile of the device 170 is not being met. For example, the device 170 may require more capacity (due to a collective capacity requirement of the downstream STAs utilizing the device 170) than is available using path (via used wireless signal 501) from the first AP 110 to the root AP 150.

At 760, the device 170 may select a new serving AP for the device 170. For example, the device 170 may use the delay-focused selection technique or the capacity-focused selection technique described in FIG. 9, depending on the type of traffic being sent to or received by the device 170. In the example of FIG. 7, the device 170 selects the second AP 120 as the new serving AP. At 761, the device 170 may send a topology change request message (which also may be referred to as an upstream AP switch request) to the root AP 150. Similarly, the device 170 may send messages (shown at 764 and 766) to the first AP 110 (current serving AP) and the second AP 120 (new serving AP), respectively, to inform them of the serving AP selection. At 762, the root AP 150 may approve or acknowledge the topology change request (such as an upstream AP switch response message).

After the steering, the device 170 has a wireless association (shown as a used wireless signal 582) with the second AP 120. The device 170 may discontinue using the first AP 110 (shown as an unused wireless signal 581).

At 790, the device 170 may send a topology change finish message (which also may be referred to as an upstream AP switch finish message) to the root AP 150. At 792, the root AP 150 may acknowledge the topology change finish message by sending a topology change finish response message. At 796, the root AP 150 may update a topology database for the network and recalculate routing/paths for the network.

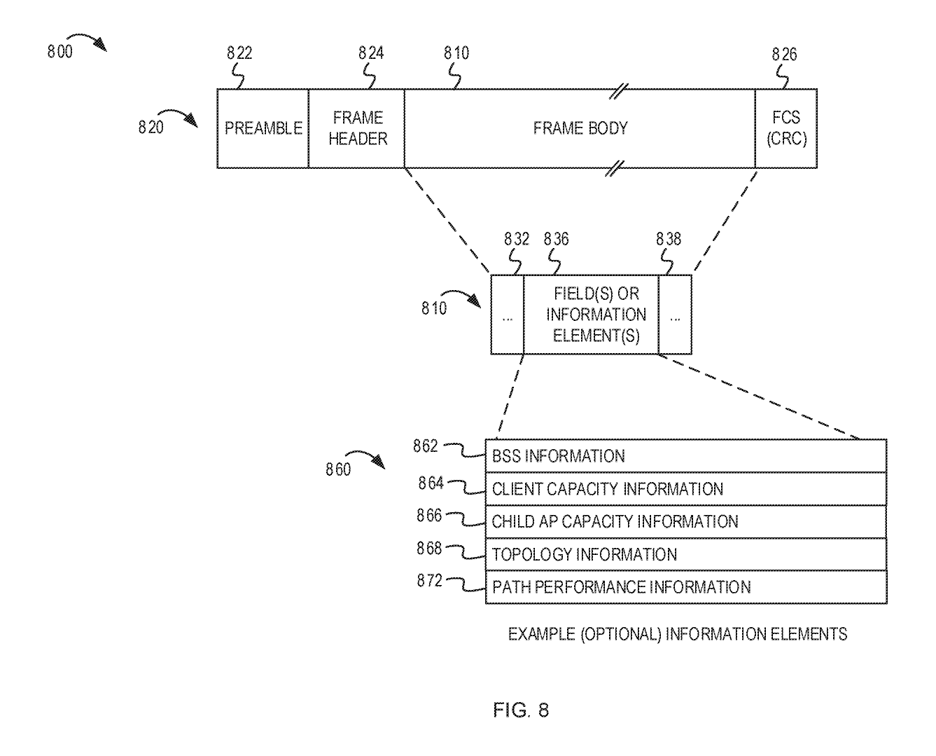

FIG. 8 depicts an example conceptual diagram of a message for sharing information used for serving AP selection. For example, the message may be sent from one AP (including the root AP) to another AP. FIG. 8 includes an example data frame 820. The data frame 820 may include a preamble 822, a frame header 824, a frame body 810, and a frame check sequence (FCS) 826. The preamble 822 may include one or more bits to establish synchronization. The frame header 824 may include source and destination network addresses (such as the network address of the sending AP and receiving AP, respectively), the length of data frame, or other frame control information. The frame body 810 may be organized with a message format and may include a variety of fields or information elements 832, 836, and 838.

Various fields or information elements may be used to share topology and performance information regarding a described AP. Several examples of information elements 860 are illustrated in FIG. 8. The information elements may include BSS information 862. For example, the BSS information 862 may include channel utilization, number of wireless clients, number of child APs, link data rate, and scheduling behavior. For example, the information elements may include channel utilization for one or more channels being used by the described AP. The information elements may include client capacity information 864 for estimating available capacity for an additional client of the BSS. The information elements may include child AP capacity information 866 for estimating available capacity for an additional child AP of the BSS. The information elements may include topology information 868 for describing one or more paths between the described AP and the root AP. The information elements may include path performance information 872, such as a hop count for each path from the described AP to the root AP, or delay metrics regarding each path from the described AP to the root AP.

FIG. 9 depicts a flowchart for serving AP selection used for steering a device. The serving AP selection techniques in FIG. 9 may be used to select a new serving AP for a device (such as a client station) and may be performed by a serving AP selection unit in the root AP, the current serving AP, another AP in the network, or a child AP. The flowchart 900 begins at block 910. At block 910, the serving AP selection unit may determine whether a device has delay sensitive traffic. For example, the serving AP selection unit may detect a type of traffic (voice over IP, video over IP, H.323, UDP, or other type of traffic) that is associated with delay sensitive traffic. In some implementations, the device may send an indication of a QoS reservation that indicates delay sensitive traffic. In some implementations, the source or destination address associated with the traffic may be used to detect delay sensitive traffic. In some implementations, packet inspection or packet stream analysis may be used to identify delay sensitive traffic. For example, a field in the packet (such as a Diff-Serve Code Point, DSCP, or other QoS-related field) might identify a low latency delay requirement. In another example, the pattern of packets in a stream (such as packet size, inter-arrival times, or other sequential packet timing) could be used to identify a packet stream that is associated with delay sensitive traffic.

At decision 920, if the device has delay sensitive traffic, the flowchart continues with a delay-focused selection technique that begins at block 940. Otherwise, if the device does not have delay sensitive traffic, the flowchart continues to a capacity-focused selection technique that begins at block 930.

The capacity-focused selection technique begins at block 930. At block 930, the serving AP selection unit may determine a subset of the candidate paths that meet the capacity requirement (such as the candidate paths that have an end-to-end path capacity higher than the capacity requirement) of the device. At decision 950, the serving AP selection unit may determine if the subset includes more than one candidate path that meets the capacity requirement. At decision 950, if the subset includes more than one candidate paths that meet the capacity requirement, the flowchart continues to block 980. At block 980, the serving AP selection unit may select a target path that has the lowest end-to-end delay (from among the candidate paths that meet the capacity requirement). At decision 950, if the subset does not include more than one candidate paths (for example zero or only one candidate paths) that meet the capacity requirement, the flowchart continues to block 970. At block 970, the serving AP selection unit may select a target path having the highest end-to-end path capacity. Thus, in the capacity-focused selection technique, the end-to-end path capacity is a first threshold criterion for selecting the target path, while the end-to-end delay is a secondary consideration for selecting the target path.

The delay-focused selection technique begins at block 940. At block 940, the serving AP selection unit may determine a subset of candidate paths that meet the delay requirement (such as the candidate paths that have an end-to-end delay less than the delay requirement) of the device. At decision 960, the serving AP selection unit may determine if the subset includes more than one candidate path that meets the delay requirement. At decision 960, if the subset includes more than one candidate paths that meet the delay requirement, the serving AP selection unit may use a capacity-focused selection technique using the subset of candidate paths that meet the delay requirement. For example, from decision 960, the flowchart may return to decision 950 (but using the subset based on delay requirement rather than capacity requirement.) At decision 950, the serving AP selection unit may determine if the subset includes more than one candidate path that meets the capacity requirement. At decision 950, if the subset of candidate paths that meet the delay requirement also includes more than one candidate paths that meet the capacity requirement, the flowchart continues to block 980. At block 980, the serving AP selection unit may select a target path that has the lowest end-to-end delay (from among the candidate paths that meet both the delay requirement and the capacity requirement). At decision 950, if the subset of candidate paths that meet the delay requirement does not include more than one candidate path that meets the capacity requirement, the flowchart continues to block 970. At block 970, the serving AP selection unit may select a target path having the highest end-to-end path capacity (from among the candidate paths that meet the delay requirement).

At decision 960, if the subset of candidate paths that meet the delay requirement does not include more than one candidate paths that meets the delay requirement, the flowchart continues to block 980. At block 980, the serving AP selection unit may select a target path having the lowest end-to-end delay. Thus, in the delay-focused selection technique, the end-to-end delay is a first threshold criterion (and final deciding factor) for selecting the target path, while the end-to-end path capacity is a secondary consideration for selecting the target path.

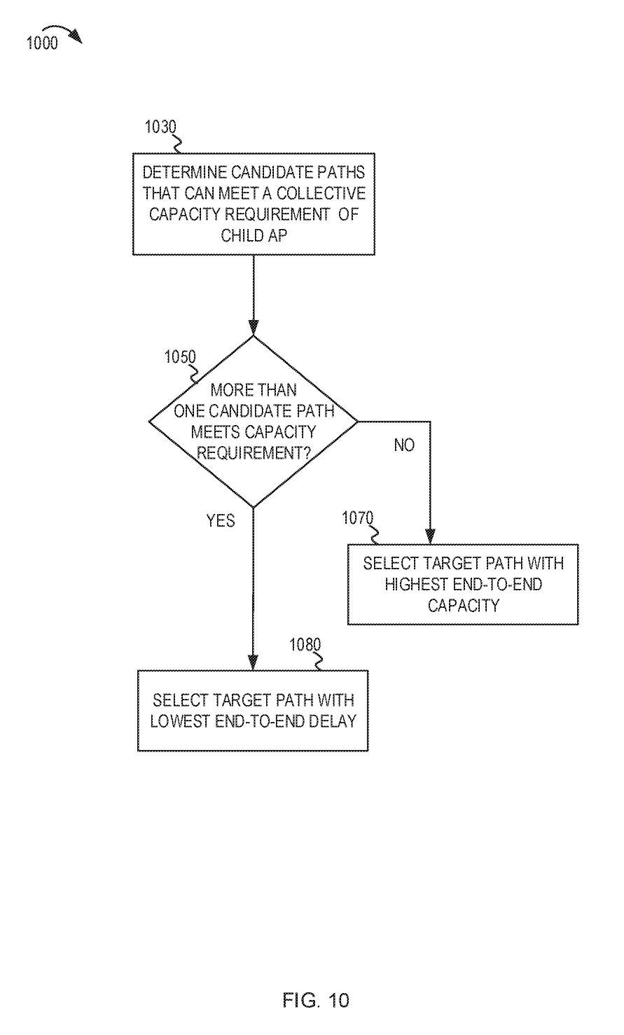

FIG. 10 depicts a flowchart for serving AP selection used for a topology change. The serving AP selection technique in FIG. 10 may be used to select a new serving AP for a device (such as a child AP) and may be performed as a topology change by a serving AP selection unit in the root AP, the current serving AP, another AP in the network, or the child AP. The flowchart 1000 begins at block 1030. At block 1030, the serving AP selection unit may determine candidate paths that can meet a collective QoS profile of the device (which may be based on an aggregation of the QoS profiles of the downstream STAs using the device). In some implementations, the capacity or delay requirements may represent a current QoS profile (based on currently existing traffic). In other implementations, the QoS profile may be determined as a long-term QoS profile expected that is based on previous traffic patterns over a period of time. For example, the long-term QoS profile may be an average of capacity requirements (or delay requirements) for the device over the period of time. For brevity, the example in FIG. 10 is based on a capacity-focused selection technique and the QoS profile is a capacity requirement.

At decision 1050, the serving AP selection unit may determine if more than one candidate path meets the capacity requirement. At decision 1050, if there are more than one candidate paths that meet the capacity requirement, the flowchart continues to block 1080. At block 1080, the serving AP selection unit may select a target path having the lowest end-to-end delay (from among the candidate paths that meet the capacity requirement). At decision 1050, if there are not more than one candidate paths that meet the capacity requirement, the flowchart continues to block 1070. At block 1070, the serving AP selection unit may select a target path having the highest end-to-end capacity.

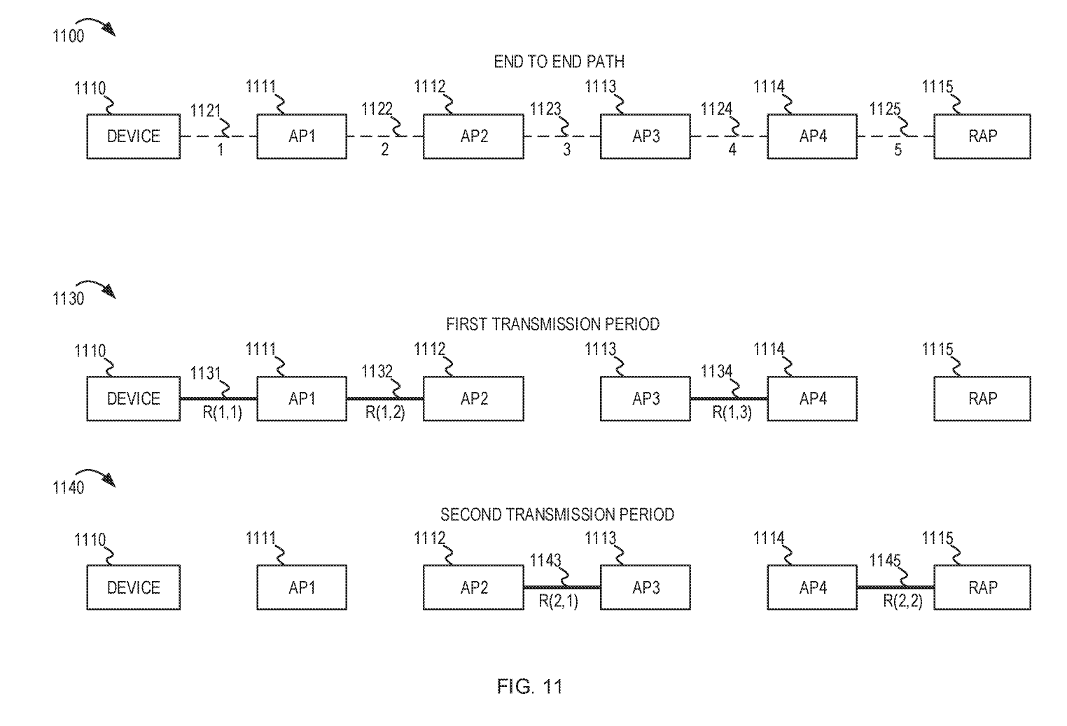

FIG. 11 depicts an example conceptual diagram showing estimation of an end-to-end capacity based on a contention-based graph of a candidate path. For example, estimating an end-to-end capacity for the candidate path may include estimating an end-to-end transmission schedule over a contention-based graph of the candidate path. FIG. 11 shows an example first path 1100 between a device 1110 (such as a STA or a child AP) and a root AP 1115. The first path 1100 includes intermediate APs 1111, 1112, 1113, 1114 between the device 1110 and the root AP 1115. The first path 1100 includes a plurality of links (shown as 1121, 1122, 1123, 1124, and 1125) between the APs of the first path.

There may be many ways to estimate an end-to-end capacity for the first path 1100. For example, the end-to-end capacity may be based on a combination of capacity constraints for each of the plurality of links in the first path 1100. In some implementations, the end-to-end capacity may be based, at least in part, on a lower bound (also referred to as a lower estimated end-to-end capacity) and an upper bound (an upper estimated end-to-end capacity). The lower bound and upper bound may be estimated taking into account the physical transmission rates, availability, and utilization of the plurality of links that make up the first path 1100.

In some implementations, an estimation of the end-to-end path capacity may include estimating link capacities for a plurality of links in the candidate path. A lower bound of the end-to-end path capacity may be estimated based, at least in part, on the plurality of links being utilized sequentially during a plurality of contention free periods. An upper bound of the end-to-end path capacity may be estimated based, at least in part, on non-overlapping ones of the plurality of links being utilized concurrently during the plurality of contention free periods. The end-to-end path capacity may be estimated based, at least in part, on the lower bound and the upper bound.

In some implementations, the lower bound may be calculated by assuming K contention free periods, where each link is assigned to one of the contention free periods. This might be a lower end-to-end capacity than actually possible in the network, since some capacity of the links can be used during concurrent contention free periods. The upper bound may provide a theoretical maximum capacity by considering capacity in a formula that minimizes the number of contention free periods used to transmit the traffic over the first path.

Lower Bound:

FIG. 11 includes a visual example showing how contention free periods can be considered when estimating the lower bound of the end-to-end capacity. In the example of FIG. 11, there are two transmission (TX) periods. An end-to-end schedule for transmission over the first path may include transmissions during a first TX period 1130 and transmissions during a second TX period 1140. The first TX period 1130 may support concurrent transmission for 3 links of the path, while the second TX period 1140 may support concurrent transmission of 2 links of the path. These are variables that may be different in other networks. A first TX period path capacity associated with the first TX period 1130 may be based on transmission rates for link 1131 (between the device 1110 and AP₁ 1111), link 1132 (between AP₁ 1111 and AP₂ 1112), and link 1134 (between AP₃ 1113 and AP₄ 1114). A second TX period path capacity associated with the second TX period 1140 may be based on transmission rates for link 1143 (between AP2 1112 and AP3 1113) and link 1145 (between AP4 1114 and root AP 1115). Each of the links 1131, 1132, 1134, 1143, and 1145 may support different transmission rates, represented by R(k,l), where k is the k^{th} transmission period and l is the l^{th} link utilizing the k^{th} transmission period. A formula for calculating the lower bound (using the above described contention periods) can be represented as follows:

$${C}_{lower} = \frac{1}{( \frac{1}{min [ R ( 1 , 1 ) , R ( 1 , 2 ) , R ( 1 , 3 ) ]} + \frac{1}{min [ R ( 2 , 1 ) , R ( 2 , 2 ) ]} )} \qquad ( 1 )$$

Upper Bound:

A formula to calculate the upper bound of the end-to-end capacity may be derived from a linear programming problem. The formula is designed to minimize the sum of contention free periods while assuming every link may serve the same amount of traffic over all contention free periods. The upper bound calculation includes listing all contention free graphs (including subgraph). Below is a synopsis of the upper bound calculation:

Assume the link capacity is Rₗ, l=1, 2, . . . , L
Assign the TX period of each graph as Tₖ, k=1, 2, . . . , K
Solve the following linear programming problem:

$$\begin{matrix}Minimize {\sum }_{k = 1}^{K} {T}_{k} & ( 2 ) \\ Subject to {T}_{k} \geq 0 , ( {\sum }_{k ∈ \{ FCG \vert l ∈ FCG \}} {T}_{k} ) {R}_{l} ≡ Const , l = 1 , 2 , … , L & ( 3 ) \\ Upper bound is \text{:} {C}_{Upper} = \frac{ ( {\sum }_{k ∈ \{ FCG \vert l ∈ FCG \}} {T}_{k} ) {R}_{l}}{{\sum }_{k = 1}^{K} {T}_{k}} & ( 4 )\end{matrix}$$

Once the lower bound and upper bound have been estimated, the end-to-end path capacity can be estimated based on the lower bound and the upper bound. For example, the end-to-end path capacity can be a number between the lower bound and the upper bound.

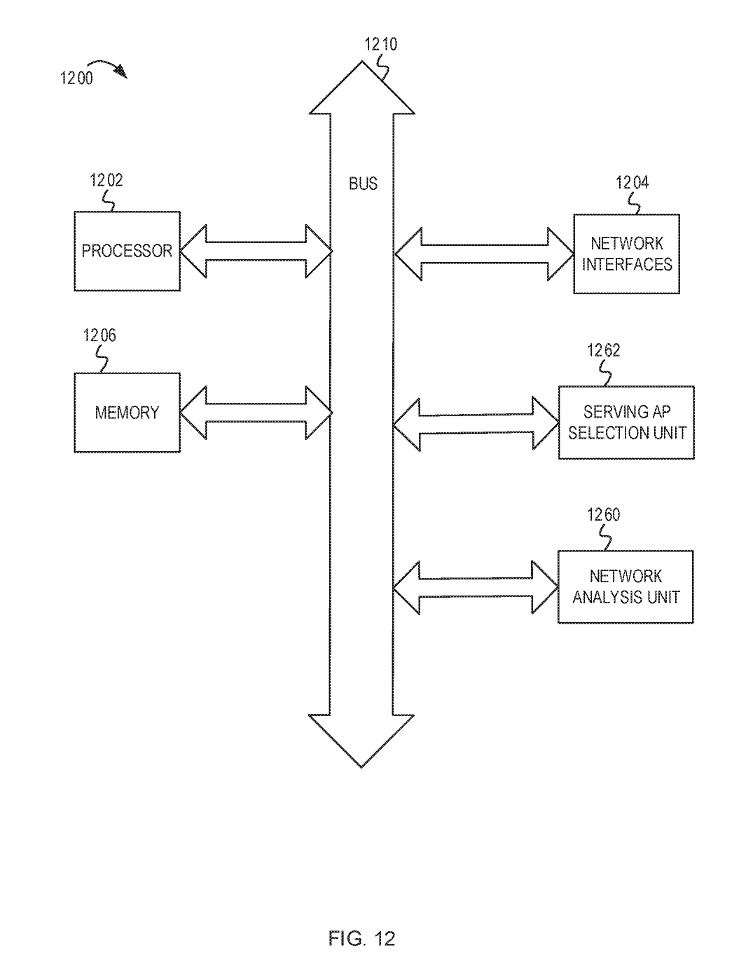

FIG. 12 shows a block diagram of an example electronic device for implementing aspects of this disclosure. In some implementations, the electronic device 1200 may be one of an access point (including any of the APs described herein), a range extender, or other electronic systems. The electronic device 1200 can include a processor unit 1202 (possibly including multiple processors, multiple cores, multiple nodes, or implementing multi-threading, etc.). The electronic device 1200 also may include a memory unit 1206. The memory unit 1206 may be system memory or any one or more of the below described possible realizations of computer-readable media. The electronic device 1200 also may include a bus 1210 (such as PCI, ISA, PCI-Express, HyperTransport®, InfiniBand®, NuBus, AHB, AXI, etc.), and a network interface 1204 that can include at least one of a wireless network interface (such as a WLAN interface, a Bluetooth® interface, a WiMAX interface, a ZigBee® interface, a Wireless USB interface, etc.) and a wired network interface (such as an Ethernet interface, a powerline communication interface, etc.). In some implementations, the electronic device 1200 may support multiple network interfaces—each of which is configured to couple the electronic device 1200 to a different communication network.

The network interface 1204 may include wireless transceivers such as a first transceiver and a second transceiver described in FIG. 2 above. The electronic device 1200 may include a network analysis unit 1260 (similar to the network analysis unit 260 described in FIG. 2) and a serving AP selection unit 1262 (similar to the serving AP selection unit described in FIGS. 9-10 or the serving AP selection unit 262 described in FIG. 2). In some implementations, the network analysis unit 1260 and serving AP selection unit 1262, can be distributed within the processor unit 1202, the memory unit 1206, and the bus 1210. The network analysis unit 1260 and serving AP selection unit 1262 can perform some or all of the operations described in FIGS. 1-11 above. The network analysis unit 1260 can determine topology and performance information regarding other APs in the network. The serving AP selection unit 1262 can select a new target serving AP from among the APs in the network using the topology and performance information obtained by the network analysis unit 1260. The serving AP selection unit 1262 can steer a device (such as a client STA or child AP) to the new target serving AP.

The memory unit 1206 can include computer instructions executable by the processor unit 1202 to implement the functionality of the implementations described in FIGS. 1-11 above. Any one of these functionalities may be partially (or entirely) implemented in hardware and/or on the processor unit 1202. For example, the functionality may be implemented with an application specific integrated circuit, in logic implemented in the processor unit 1202, in a co-processor on a peripheral device or card, etc. Further, realizations may include fewer or additional components not illustrated in FIG. 12 (such as video cards, audio cards, additional network interfaces, peripheral devices, etc.). The processor unit 1202, the memory unit 1206, the network interface 1204, and the network configurator unit 1208 are coupled to the bus 1210. Although illustrated as being coupled to the bus 1210, the memory unit 1206 may be coupled to the processor unit 1202.

FIGS. 1-12 and the operations described herein are examples meant to aid in understanding example implementations and should not be used to limit the potential implementations or limit scope of the claims. Some implementations may perform additional operations, fewer operations, operations in parallel or in a different order, and some operations differently.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, or, any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray™ disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A first access point (AP) for use in a network, comprising:
a processor; and
memory having instructions stored therein which, when executed by the processor cause the first AP to:
determine that a wireless connection between the first AP and a device does not meet a quality of service (QoS) profile of the device, wherein the QoS profile includes at least one of a capacity requirement and a delay requirement of the device;
estimate path performance metrics for each of a plurality of candidate paths between the device and a root AP of the network, wherein the path performance metrics include estimated path capacity and estimated path delay;
select a target path from among the plurality of candidate paths based, at least in part, on a comparison of the QoS profile of the device with the estimated path performance metrics, the target path comprising a plurality of links between a second AP and the root AP; and
steer the device from the first AP to the second AP.

2. The first AP of claim 1, wherein the device is a client station, and wherein the instructions to determine that the wireless connection does not meet the QoS profile of the device include instructions which, when executed by the processor, cause the first AP to perform at least one operation selected from the group consisting of:
determining that the capacity requirement of the client station exceeds a first capacity of a first path from the first AP to the root AP;
determining that the first path does not meet the delay requirement of the client station; and
receiving an indication from the client station indicating that the QoS profile is not being met by the wireless connection.

3. The first AP of claim 1, wherein the device is a child AP, and wherein the instructions to determine that the wireless connection does not meet the QoS profile of the device include instructions which, when executed by the processor, cause the first AP to perform at least one operation selected from the group consisting of:
determining that a current topology of the network does not meet a collective capacity requirement of a plurality of client stations associated with the child AP; and
determining a chronic condition resulting from the child AP being unable to meet the collective capacity requirement of the plurality of client stations.

4. The first AP of claim 1, wherein the instructions, when executed by the processor, further cause the first AP to:
obtain topology information of the network; and
determine the plurality of candidate paths between the device and the root AP of the network based, at least in part, on the topology information.

5. The first AP of claim 1, wherein the instructions, when executed by the processor, further cause the first AP to:
obtain performance information regarding a plurality of APs in the network, the performance information including traffic flow parameters regarding one or more clients of the plurality of APs, wherein the estimated path performance metrics are based, at least in part, on the performance information regarding the plurality of APs.

6. The first AP of claim 5, wherein the instructions to obtain the performance information include instructions which, when executed by the processor, cause the first AP to:
send a query to at least the second AP, the query for requesting the performance information from the second AP, wherein the performance information describes at least one link in a candidate path between the root AP and the second AP; and
receive a response from the second AP, the response including the performance information.

7. The first AP of claim 5, wherein the instructions to obtain the performance information include instructions which, when executed by the processor, cause the first AP to:
send, to the root AP of the network, a request for the performance information; and
receive a response from the root AP, the response including the performance information regarding the plurality of APs collected by the root AP.

8. The first AP of claim 7, wherein the response includes topology information regarding a current topology of the network.

9. The first AP of claim 5, wherein the instructions to obtain the performance information include instructions when, when executed by the processor, cause the first AP to obtain the performance information from the second AP, and wherein the performance information includes at least one member selected from the group consisting of:
basic service set (BSS) information regarding a BSS at the second AP, the BSS information including channel utilization, number of wireless clients, number of child APs, link data rate, and scheduling behavior;
overlapping BSS (OBSS) channel utilization;
client capacity information for estimating available capacity for an additional client of the BSS;
child AP capacity information for estimating available capacity for an additional child AP of the BSS;
topology between the second AP and neighboring APs;
hop count for each path from the second AP to the root AP; and
delay metrics regarding each path from the second AP to the root AP.

10. The first AP of claim 1, wherein the instructions to estimate the path performance metrics for a candidate path include instructions which, when executed by the processor, cause the first AP to perform at least one operation selected from the group consisting of:
estimating an end-to-end path capacity for the candidate path between a serving AP of the candidate path and the root AP;
estimating a hop count for the candidate path based, at least in part, on a quantity of intermediate APs in the candidate path;
estimating an end-to-end delay between the serving AP of the candidate path and the root AP; and
estimating a channel available airtime of a target BSS at the serving AP.

11. The first AP of claim 1, wherein the estimated path capacity for a candidate path between a serving AP and the root AP includes an end-to-end path capacity, and wherein the instructions to estimate the path performance metrics include instructions which, when executed by the processor, cause the first AP to estimate an end-to-end transmission schedule over a contention-based graph of the candidate path.

12. The first AP of claim 11, wherein the instructions, when executed by the processor, further cause the first AP to:
estimate link capacities for a plurality of links in the candidate path;
estimate a lower bound of the end-to-end path capacity based, at least in part, the plurality of links being utilized sequentially during a plurality of contention free periods;
estimate an upper bound of the end-to-end path capacity based, at least in part, non-overlapping ones of the plurality of links being utilized concurrently during the plurality of contention free periods; and
estimate the end-to-end path capacity based, at least in part, on the lower bound and the upper bound of the end-to-end path capacity.

13. The first AP of claim 1, wherein the device is a client station, and wherein the instructions to select the target path include instructions which, when executed by the processor, cause the first AP to:
determine whether the client station has delay sensitive traffic;
if the client station has delay sensitive traffic, utilize a delay-focused selection technique to select the target path; and
if the client station does not have delay sensitive traffic, utilize a capacity-focused selection technique to select the target path.

14. The first AP of claim 13, wherein the instructions to utilize the capacity-focused selection technique include instructions which, when executed by the processor, cause the first AP to:
determine a subset of the plurality of candidate paths that has an end-to-end path capacity higher than the capacity requirement of the client station;
if the subset includes more than one candidate path, select the target path that has a lowest end-to-end delay from among the subset; and
if the subset does not include more than one candidate path, select the target path that has a highest end-to-end path capacity from among the plurality of candidate paths.

15. The first AP of claim 13, wherein the instructions to utilize the delay-focused selection technique include instructions which, when executed by the processor, cause the first AP to:
determine a subset of the plurality of candidate paths that has an end-to-end delay less than the delay requirement of the client station;
if the subset includes more than one candidate path, select the target path from among the subset based, at least in part, on an end-to-end capacity for each of the candidate paths in the subset; and
if the subset does not include more than one candidate path, select the target path that has a lowest end-to-end delay from among the plurality of candidate paths.

16. The first AP of claim 15, wherein the instructions to select the target path from among the subset based, at least in part, on an end-to-end capacity include instructions which, when executed by the processor, cause the first AP to:
if the subset of the candidate paths that have an end-to-end delay less than the delay requirement of the client station includes more than one candidate path that has an end-to-end capacity higher than the capacity requirement of the client station, select the target path that has a lowest end-to-end delay from among the candidate paths that have an end-to-end capacity higher than the capacity requirement of the client station; and
if the subset of the candidate paths that have an end-to-end delay less than the delay requirement of the client station does not include more than one candidate path that has an end-to-end capacity higher than the capacity requirement of the client station, select the target path that has a highest end-to-end capacity from among the subset.

17. The first AP of claim 1, wherein the device is a child AP, and wherein the instructions to select the target path include instructions which, when executed by the processor, cause the first AP to:
if more than one of the plurality of candidate paths have an end-to-end capacity higher than the capacity requirement of the child AP, select the target path that has a lowest end-to-end delay from among the candidate paths that have an end-to-end capacity higher than the capacity requirement of the child AP; and
otherwise, select the target path that has a highest end-to-end capacity from among the plurality of candidate paths.

18. A method performed by a first access point (AP), the method comprising:
determining that a wireless connection between the first AP and a device does not meet a quality of service (QoS) profile of the device, wherein the QoS profile includes at least one of a capacity requirement and a delay requirement of the device;
estimating path performance metrics for each of a plurality of candidate paths between the device and a root AP of the network, wherein the path performance metrics include estimated path capacity and estimated path delay;
selecting a target path from among the plurality of candidate paths based, at least in part, on a comparison of the QoS profile of the device with the estimated path performance metrics, the target path comprising a plurality of links between a second AP and the root AP; and
steering the device from the first AP to the second AP.

19. The method of claim 18, wherein the device is a client station, and wherein determining that the wireless connection does not meet the QoS profile of the device comprises at least one member selected from the group consisting of:
determining that the capacity requirement of the client station exceeds a first capacity of a first path from the first AP to the root AP;
determining that the first path does not meet the delay requirement of the client station; and
receiving an indication from the client station indicating that the QoS profile is not being met by the wireless connection.

20. The method of claim 18, further comprising:
obtaining topology information of the network; and
determining the plurality of candidate paths between the device and the root AP of the network based, at least in part, on the topology information.

21. The method of claim 18, further comprising:
obtaining performance information regarding a plurality of APs in the network, wherein the estimated path performance metrics are based, at least in part, on the performance information regarding the plurality of APs.

22. The method of claim 18, wherein estimating the path performance metrics for a candidate path includes at least one member selected from the group consisting of:
estimating an end-to-end path capacity for the candidate path between a serving AP of the candidate path and the root AP;
estimating a hop count for the candidate path based, at least in part, on a quantity of intermediate APs in the candidate path;
estimating an end-to-end delay between the serving AP of the candidate path and the root AP; and
estimating a channel available airtime of a target BSS at the serving AP.

23. The method of claim 18, wherein the estimated path capacity for a candidate path between a serving AP and the root AP includes an end-to-end path capacity, and wherein estimating the path performance metrics includes estimating an end-to-end transmission schedule over a contention-based graph of the candidate path.

24. The method of claim 23, further comprising:
estimating link capacities for a plurality of links in the candidate path;
estimating a lower bound of the end-to-end path capacity based, at least in part, the plurality of links being utilized sequentially during a plurality of contention free periods;
estimating an upper bound of the end-to-end path capacity based, at least in part, non-overlapping ones of the plurality of links being utilized concurrently during the plurality of contention free periods; and
estimating the end-to-end path capacity based, at least in part, on the lower bound and the upper bound of the end-to-end path capacity.

25. The method of claim 18, wherein the device is a client station, and wherein selecting the target path comprises:
determining whether the client station has delay sensitive traffic;
if the client station has delay sensitive traffic, utilizing a delay-focused selection technique to select the target path; and
if the client station does not have delay sensitive traffic, utilizing a capacity-focused selection technique to select the target path.

26. A computer-readable medium having stored therein instructions which, when executed by a processor of a first access point (AP), causes the first AP to:
determine that a wireless connection between the first AP and a device does not meet a quality of service (QoS) profile of the device, wherein the QoS profile includes at least one of a capacity requirement and a delay requirement of the device;
estimate path performance metrics for each of a plurality of candidate paths between the device and a root AP of the network, wherein the path performance metrics include estimated path capacity and estimated path delay;
select a target path from among the plurality of candidate paths based, at least in part, on a comparison of the QoS profile of the device with the estimated path performance metrics, the target path comprising a plurality of links between a second AP and the root AP; and
steer the device from the first AP to the second AP.

27. The computer-readable medium of claim 26, wherein the instructions, when executed by the processor, further cause the first AP to:
obtain performance information regarding a plurality of APs in the network, wherein the estimated path performance metrics are based, at least in part, on the performance information regarding the plurality of APs.

28. The computer-readable medium of claim 26, wherein the estimated path capacity for a candidate path between a serving AP and the root AP includes an end-to-end path capacity, and wherein estimating the path performance metrics includes estimating an end-to-end transmission schedule over a contention-based graph of the candidate path.

29. A system, comprising:
means for determining that a wireless connection between a first access point (AP) and a device does not meet a quality of service (QoS) profile of the device, wherein the QoS profile includes at least one of a capacity requirement and a delay requirement of the device;
means for estimating path performance metrics for each of a plurality of candidate paths between the device and a root AP of the network, wherein the path performance metrics include estimated path capacity and estimated path delay;
means for selecting a target path from among the plurality of candidate paths based, at least in part, on a comparison of the QoS profile of the device with the estimated path performance metrics, the target path comprising a plurality of links between a second AP and the root AP; and
means for steering the device from the first AP to the second AP.

30. The system of claim 29, wherein the device is a client station, and wherein the means for determining that the wireless connection does not meet the QoS profile of the device comprises at least one member selected from the group consisting of:
means for determining that the capacity requirement of the client station exceeds a first capacity of a first path from the first AP to the root AP;
means for determining that the first path does not meet the delay requirement of the client station; and
means for receiving an indication from the client station indicating that the QoS profile is not being met by the wireless connection.
